(19) United States
(12) Patent Application Publication
(10) Pub. No.: US 2013/0157897 A1
(43) Pub. Date: Jun. 20, 2013

(54) METHOD AND APPARATUS FOR MAGNETIC STIRRING

(71) Applicants: Aaron Francis, San Jose, CA (US); Gregory Lim, Fremont, CA (US)

(72) Inventors: Aaron Francis, San Jose, CA (US); Gregory Lim, Fremont, CA (US)

(73) Assignee: Intermolecular, Inc., San Jose, CA (US)

(21) Appl. No.: 13/327,352

(22) Filed: Dec. 15, 2011

(51) Int. Cl. C40B 40/00

(52) U.S. Cl. 506/13

(57) ABSTRACT

A system for combinatorially processing a substrate is provided. The system includes a reactor or chemical library having a plurality of chambers defined within the reactor or library, the chambers operable to mix fluids disposed therein. A drive system is disposed below a bottom surface of the reactor. The drive system is operable to rotate a plurality of support plates below the surface of the substrate. The plurality of support plates has a non-circular shape. The non-circular shape of adjacent support plates includes extensions configured to traverse overlapping regions of rotation during rotation of adjacent support plates. Each of the extensions has a magnet disposed thereon.

### BACKGROUND

Combinatorial processing enables rapid evaluation of semiconductor processes. The systems supporting the combinatorial processing are flexible to accommodate the demands for running the different processes either in parallel, serial or some combination of the two.

Some exemplary semiconductor wet processing operations include operations for adding (electro-depositions) and removing layers (etch), defining features, preparing layers (e.g., cleans), etc. Similar processing techniques apply to the manufacture of integrated circuits (IC) semiconductor devices, flat panel displays, optoelectronics devices, data storage devices, magneto electronic devices, magneto optic devices, packaged devices, and the like. As feature sizes continue to shrink, improvements, whether in materials, unit processes, or process sequences, are continually being sought for the deposition processes. However, semiconductor companies conduct R&D on full wafer processing through the use of split lots, as the deposition systems are designed to support this processing scheme. This approach has resulted in ever escalating R&D costs and the inability to conduct extensive experimentation in a timely and cost effective manner. Combinatorial processing as applied to semiconductor manufacturing operations enables multiple experiments to be performed on a single substrate.

During combinatorial experiments it is beneficial to provide as much flexibility as possible with regard to the tools performing the processing. In addition, the equipment for performing the combinatorial experiments should be designed to reproducibly perform the experiments in order to effectively evaluate the results of the experiments. It is within this context that the embodiments arise.

### SUMMARY

Embodiments of the present invention provide an apparatus that improves the coverage of the magnetic stirring. Several inventive embodiments of the present invention are described below.

In some embodiments of the invention, a system for combinatorially processing a substrate is provided. The system includes a reactor having a plurality of chambers defined within the reactor, the chambers operable to mix fluids disposed therein. A drive system is disposed below a bottom surface of the reactor. The drive system is operable to rotate a plurality of support plates below the surface of the substrate. The plurality of support plates has a non-circular shape. The non-circular shape of adjacent support plates includes extensions configured to traverse overlapping regions of rotation at different times during rotation of adjacent support plates. Each of the extensions has a magnet disposed thereon.

Other aspects of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration that includes site isolated processing and/or conventional processing in accordance with some embodiments of the invention.

FIG. 3 is a simplified schematic diagram illustrating a combinatorial processing system in accordance with some embodiments of the invention.

FIG. 4 is a simplified schematic diagram illustrating a cross-sectional view of the combinatorial processing system in accordance with some embodiments of the invention.

FIG. 5 is a simplified schematic diagram illustrating a perspective view of the drive system in accordance with some embodiments of the invention.

FIGS. 6A through 6D illustrate various shapes for the support plates where regions of rotation of the support plates intersect or overlap in accordance with some embodiments of the invention.

### DETAILED DESCRIPTION

The embodiments described herein provide a method and apparatus for improving mixing of fluids. It will be obvious, however, to one skilled in the art, that the present invention may be practiced without some or all of these specific details. In other instances, well known process operations have not been described in detail in order not to unnecessarily obscure the present invention.

The embodiments describe an apparatus for improving the mixing for the staging vials for a processing unit. The embodiments avoid dead spaces so that all mixing or staging vials in the block configuration of the apparatus receive complete stirring. Through the interlocking/overlapping configuration of this disclosure, the dead spaces are eliminated. The overlapping configuration includes a motor driven pulley system where a single motor drives a plurality of pulleys which in turn drive plates having the magnets disposed thereon. Alternative drive configurations including dedicated motors for each pulley, gear drives, etc., may be included. The plates are of an irregular shape, i.e., not circular, so that the magnets disposed on the surface of the plates have overlapping areas of coverage of their magnetic fields. This overlapping coverage eliminates the dead spaces. In some embodiments, the rotation of the support plates is timed appropriately so that the irregular shapes do not collide, e.g., extended regions or protrusions of adjacent plates may collide if these extended regions are simultaneously at the same point in the rotation.

Semiconductor manufacturing typically includes a series of processing steps such as cleaning, surface preparation, deposition, patterning, etching, thermal annealing, and other related unit processing steps. The precise sequencing and integration of the unit processing steps enables the formation of functional devices meeting desired performance metrics such as efficiency, power production, and reliability.

As part of the discovery, optimization and qualification of each unit process, it is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices such as integrated circuits. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single monolithic substrate without the need of consuming the equivalent number of monolithic substrates per material(s), processing condition(s), sequence(s) of processing conditions, sequence(s) of processes, and combinations thereof. This can greatly improve both the speed and reduce the costs associated with the discovery, implementation, optimization, and qualification of material(s), process(es), and process integration sequence(s) required for manufacturing.

Systems and methods for High Productivity Combinatorial (HPC) processing are described in U.S. Pat. No. 7,544,574 filed on February 10, 2006, U.S. Pat. No. 7,824,935 filed on Jul. 2, 2008, U.S. Pat. No. 7,871,928 filed on May 4, 2009, U.S. Pat. No. 7,902,063 filed on Feb. 10, 2006, and U.S. Pat. No. 7,947,531 filed on Aug. 28, 2009 which are all herein incorporated by reference. Systems and methods for HPC processing are further described in U.S. patent application Ser. No. 11/352,077 filed on Feb. 10, 2006, claiming priority from Oct. 15, 2005, U.S. patent application Ser. No. 11/419,174 filed on May 18, 2006, claiming priority from Oct. 15, 2005, U.S. patent application Ser. No. 11/674,132 filed on Feb. 12, 2007, claiming priority from Oct. 15, 2005, and U.S. patent application Ser. No. 11/674,137 filed on Feb. 12, 2007, claiming priority from Oct. 15, 2005 which are all herein incorporated by reference.

HPC processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD).

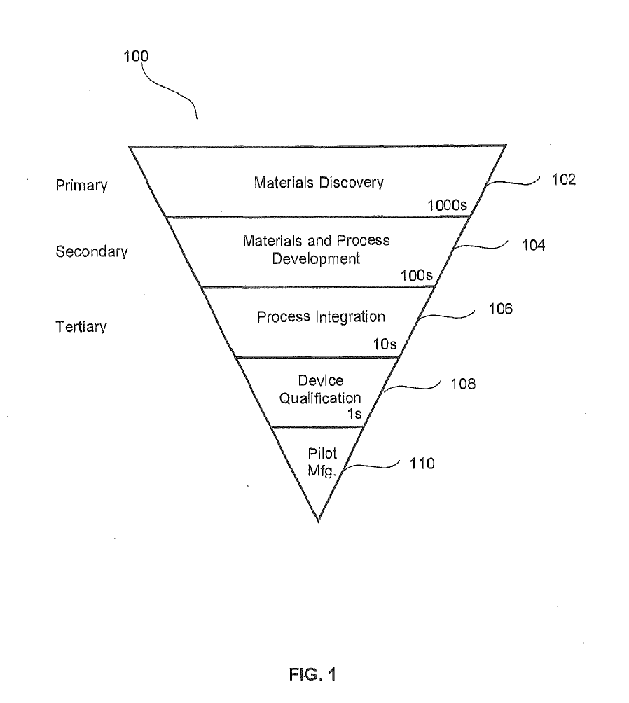

FIG. 1 illustrates a schematic diagram, 100, for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using metrology tools such as electronic testers and imaging tools (i.e., microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing, 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways.

This application benefits from High Productivity Combinatorial (HPC) techniques described in U.S. patent application Ser. No. 11/674,137 filed on Feb. 12, 2007 which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of semiconductor manufacturing operations by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating a device. A global optimum sequence order is therefore derived and as part of this derivation, the unit processes, unit process parameters and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate are equivalent to the structures formed during actual production of the semiconductor device. For example, such structures may include, but would not be limited to, contact layers, buffer layers, absorber layers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

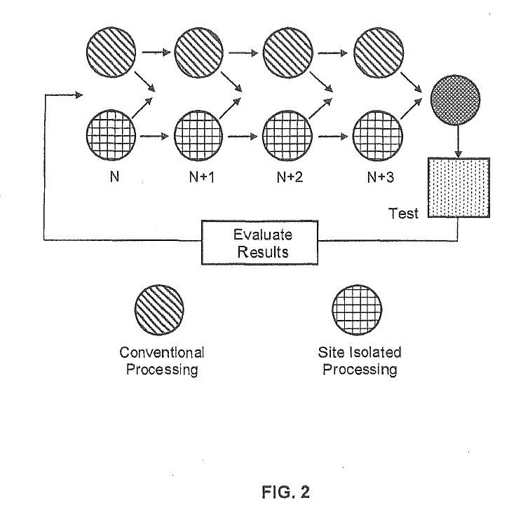

FIG. 2 is a simplified schematic diagram illustrating a general methodology for combinatorial process sequence integration that includes site isolated processing and/or conventional processing in accordance with some embodiments of the invention. In one embodiment, the substrate is initially processed using conventional process N. In one exemplary embodiment, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

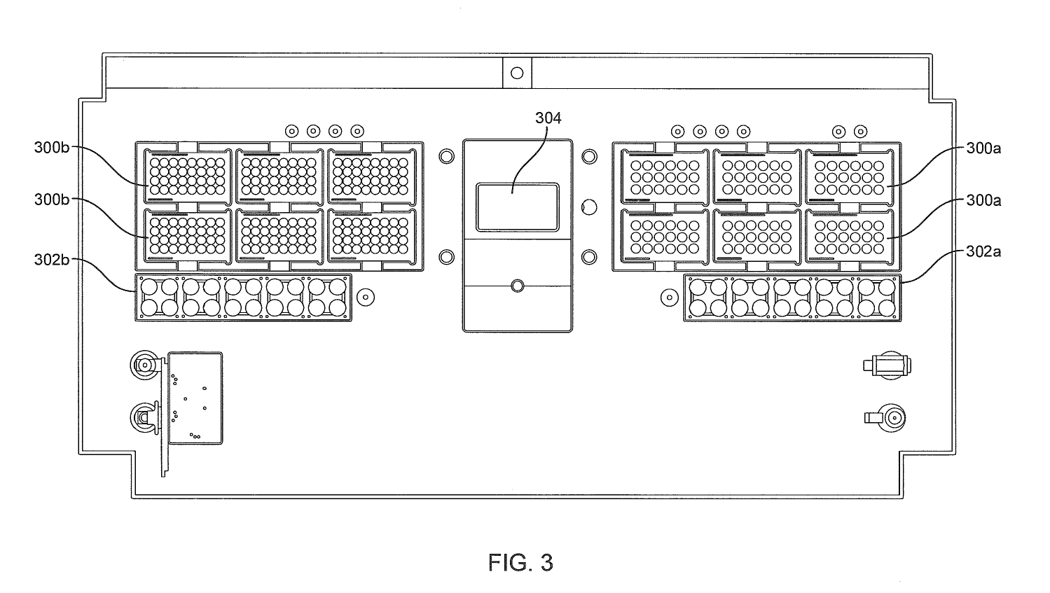

FIG. 3 is a simplified schematic diagram illustrating a combinatorial processing system in accordance with some embodiments of the invention. The combinatorial processing system includes a substrate or coupon 304 that will be processed in a combinatorial manner. Chemical libraries 300a and chemical libraries 300b are provided so that the solutions may be mixed prior to transferring the solution to a surface of coupon staged in the reactor 304. As used herein a “chemical library” is a staging vessel having a plurality or array of openings that can accept fluids for mixing prior to delivery to a reactor. The source for the different solutions provided to 300a and 300b are from source bottles 302a and 302b, respectively. It should be appreciated that while Chemical libraries 300a and Chemical libraries 300b are illustrated with certain amounts of openings or chambers for mixing solutions, this is not meant to be limiting. As discussed in more detail below, a drive system powers magnetic stirring in each of the chambers in order to ensure mixing of the solutions within the chambers. A discussion of some embodiments of the system details may be found in U.S. patent application Ser. No. 11/352,077 entitled “Methods for Discretized Processing and Process Sequence Integration of Regions of a Substrate”, filed on Feb. 10, 2006 and claiming priority to U.S. Provisional Patent Application No. 60/725,186 filed on Oct. 11, 2005, each of which are herein incorporated by reference.

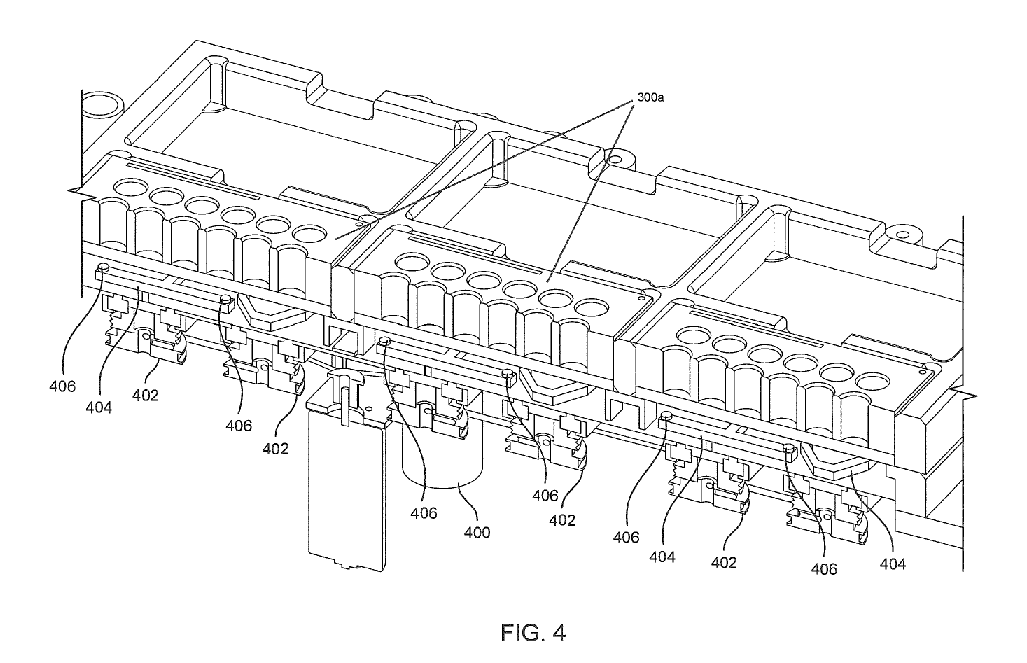

FIG. 4 is a simplified schematic diagram illustrating a cross-sectional view of the combinatorial processing system in accordance with some embodiments of the invention. Chemical libraries 300a have a plurality of reactors disposed therein. Underneath a bottom surface of Chemical libraries 300a is disposed a drive system for rotating magnetic stirrers disposed within the reactors. Drive 400 is configured to drive pulleys 402 through corresponding belts in order to rotate the pulleys and corresponding support plates 404. Support plates 404 are affixed to corresponding pulleys and therefore rotate as the pulley is driven according to drive 400 and attached belts. Support plates 404 are cross shaped in some embodiments. A top surface of support plates 404 opposing the bottom surface of reactors 300a has magnets 406 affixed thereto. Magnets 406 rotate as support plates 404 rotate. Magnets 406 are affixed to outer peripheral edges of support plates 404 in some embodiments. As illustrated in more detail below, support plates 404 rotate so that extensions of the support plate traverse intersecting or overlapping regions of rotation at different times during rotation of adjacent support plates. It should be appreciated that in this manner, the overlapping traversal of the intersecting regions of rotation eliminates any dead space where magnets 406 are unable to provide stirring for a magnetic stirrer disposed in one of the chambers of Chemical libraries 300a. It should be further appreciated that support plates 404 may have alternative shapes as described below. That is, any shape suitable to provide intersecting regions of rotation for adjacent support plates may be utilized with the embodiments described herein.

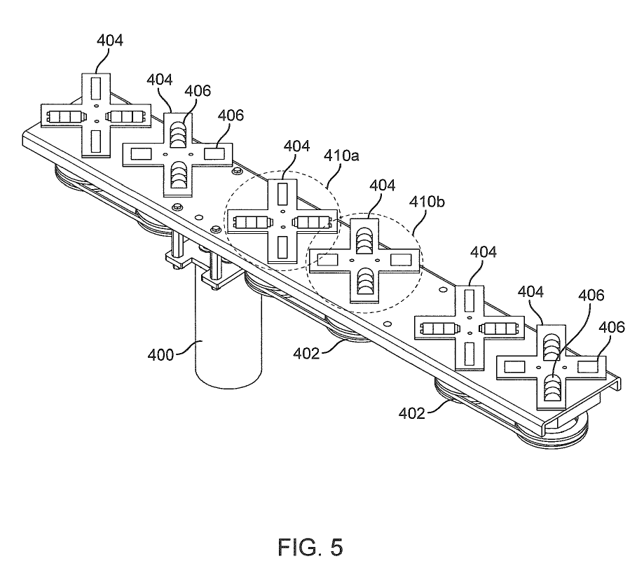

FIG. 5 is a simplified schematic diagram illustrating a perspective view of the drive system in accordance with some embodiments of the invention. The drive system includes drive 400 which is configured to rotate pulleys 402 around a corresponding axis of each of the pulleys. Drive 400 may be any suitable drive, such as a worm gear linear screw, electric motor, etc. Support plates 404 are disposed on a top surface of the drive system. Support plates 404 are configured to rotate around an axis of the support plate as driven by a corresponding pulley 402 onto which each support plate 404 is affixed. On a top surface of support plate 404 are disposed magnets 406. Magnets 406 are disposed along extensions of support plates 404 proximate to an outer peripheral edge of each of the extensions in some embodiments. As illustrated in FIG. 5, the support plates are configured so that adjacent support plates have intersecting or overlapping regions of rotations as illustrated by the intersection or overlap of rotation regions 510a and 510b. The intersecting regions of rotation ensure adequate stirring of the magnetic stirrers and the avoidance of dead spaces when the rotation regions do not intersect. It should be appreciated that the timing of the rotation of the pulleys as dictated through the coupling with the belts, ensures that the extensions of the support plates do not collide. It should be further appreciated that the direction of rotation of the support plates 404 may be identical in some embodiments or opposite in other embodiments. The configuration of the drive system illustrated in FIG. 5 is such that a single drive provides the rotation for a plurality of pulleys 402. In some embodiments, alternative drive means may be provided where multiple drives are utilized to operate the multiple pulleys 402.

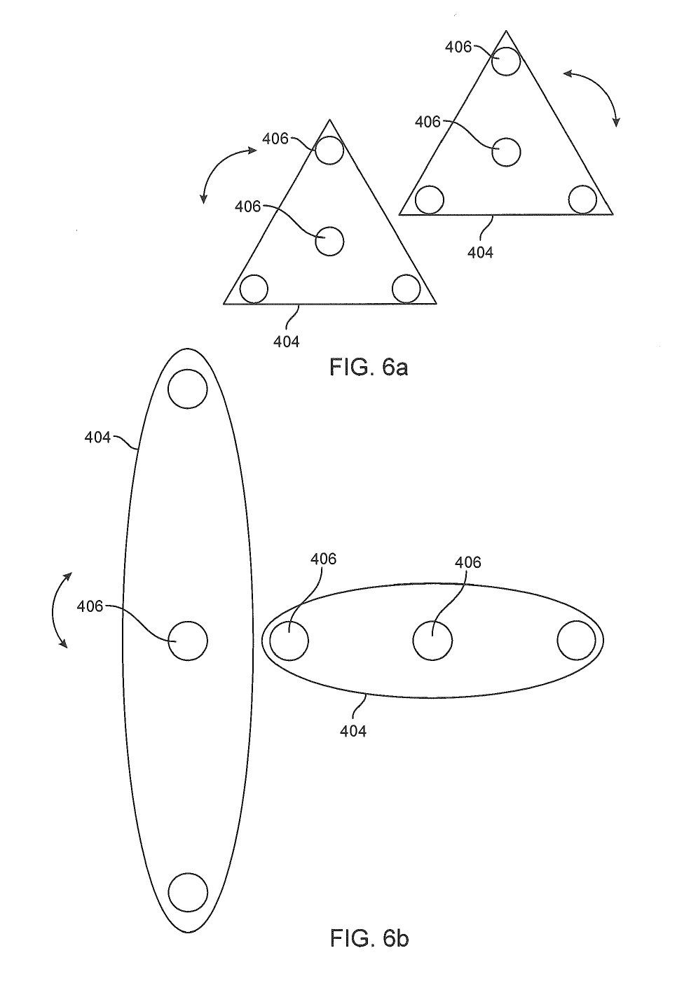

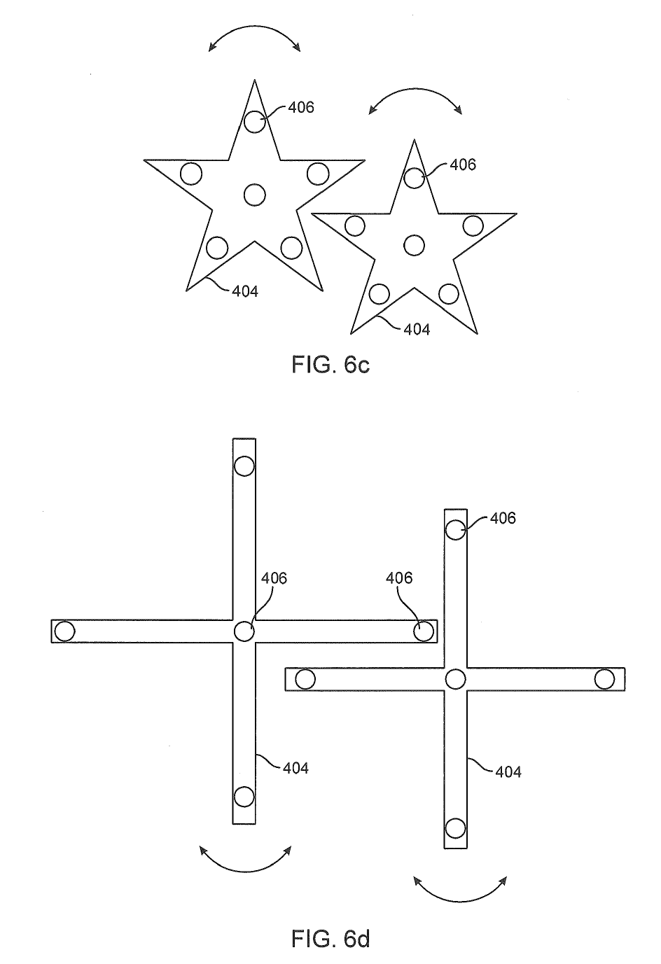

FIGS. 6A through 6D illustrate various shapes for the support plates where regions of rotation of the support plates intersect or overlap in accordance with some embodiments of the invention. In FIG. 6A, a triangular shaped is provided for each of support plates 404. Magnets 406 are placed on a top surface of support plates 404. In some embodiments, magnets 406 are placed on an axis of rotation of the support plate, which may be referred to as a central region of the support plate. Magnets 406 are also disposed on the angled extensions of each of support plates 404. FIG. 6B illustrates elliptical shapes for the support plates 404 in accordance with some embodiments of the invention. Support plates 404 include a plurality of magnets 406 disposed on a surface of the support plates. Magnets 406 are disposed proximate to an outer peripheral edge of support plates 404, as well as over an axis of rotation for each of the support plates.

FIG. 6C illustrates star shapes for support plates 404 in accordance with some embodiments of the invention. Magnets 406 are disposed on outer extensions of the star shaped support plates 404 so that the regions of rotation for the adjacent support plates overlap or intersect. FIG. 6D is a simplified schematic diagram illustrating a cross shapes for support plates 404 in accordance with some embodiments of the invention. The rotation of support plates 404 in FIGS. 6A-6D is timed in order to ensure that the extensions and corresponding magnets do not collide with each other during the rotation of the support plates. The embodiments described with regard to FIGS. 6A-D are exemplary and not meant to be limiting. It should be appreciated that any non-circular shape may be incorporated into the embodiments to eliminate the dead spaces and enhance the stirring coverage. In addition, while FIGS. 6A-D illustrate shapes that are similar with each other, different shapes may also be combined with each other. For example, the cross shape may be combined with the triangular shape, and so on. The magnets disposed on the surface of the support plates are arranged so that the polarities of the magnets provide rotation of a magnetic stirrer in the reaction chambers. In some embodiments, adjacent magnets either on the same support plate or adjacent support plates are arranged so that the polarity of the adjacent magnets is opposing to each other. The magnets may be arranged in a variety of orientations in order to provide optimum coupling or excitation to the stir bars.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims In the claims, elements and/or steps do not imply any particular order of operation, unless explicitly stated in the claims.

What is claimed is:

1. A system for mixing fluids contained in a chemical library, comprising:
a chemical library;
a plurality of plates disposed below the chemical library,
the plurality of plates comprising a first plate and a second plate,
wherein each of the first plate and the second plate has a planer surface,
wherein each of the first plate and the second plate has an axis perpendicular to its planar surface;
wherein each of the first plate and the second plate is configured to rotate around its axis,
wherein each of the first plate and the second plate has a plurality of extensions,
where each of the plurality of extensions has at least one magnet disposed thereon,
wherein the extensions of each of the first plate and the second plate define a region surrounding the plate when the plate is rotated,
wherein the first plate and second plate are adjacent to each other such that the region surrounding the first plate overlaps with the region surround the second plate,

2. The system of claim 1, wherein the adjacent plates rotate in opposing directions.

3. The system of claim 1, wherein a single drive system powers the rotation of the plurality of plates.

4. The system of claim 3, wherein the drive system includes a plurality of pulleys.

5. The system of claim 3 wherein the drive system includes a plurality of drive gears.

6. The system of claim 1 wherein a dedicated motor is used to drive each of the plurality of plates.

7. The system of claim 1, wherein the shape of each of the plates is one of a cross shape, a star shape, an elliptical shape, or a triangular shape.

8. The system of claim 1, wherein magnets disposed on each of the extensions are arranged so that adjacent magnets have opposing polarities.

9. A system for mixing fluids contained in a chemical library, comprising:
a chemical library;
a plurality of plates disposed below the chemical library, the plurality of plates comprising a first plate and a second plate,
wherein each of the first plate and the second plate has a planer surface,
wherein each of the first plate and the second plate has an axis perpendicular to its planar surface;
wherein each of the first plate and the second plate is configured to rotate around its axis,
a drive system disposed below a bottom surface of the chemical library, the drive system operable to rotate the plurality of plates.

10. The system of claim 9, wherein a dedicated motor is used to rotate each of the plurality of plates.

11. The system of claim 9, wherein a shape of each of the plates is elliptical.

12. The system of claim 9, wherein each of the plates includes one or more magnets disposed over a surface of the each of the plates.

13. The system of claim 12, wherein each of the plates is non-circular and wherein the magnets are disposed proximate to the outer peripheral edges.

14. The system of claim 12, wherein one of the magnets is disposed along an axis of rotation of one of the plurality of support plates.

15. The system of claim 13, wherein the outer peripheral edges include a plurality of angles, wherein a tip of each of the plurality of angles defines a region surrounding the plate when the plate is rotated.

16. The system of claim 15, wherein magnets disposed on each of the tips are arranged so that adjacent magnets have opposing polarities.

17. The system of claim 9, wherein a shape of each of the plurality of plates is a cross shape.

18. The system of claim 9, wherein a shape of each of the plurality of plates is a star shape.

19. The system of claim 9, wherein a shape of each of the plurality of plates is a rectangular shape.

20. The system of claim 9, wherein a shape of each of the plurality of plates is a triangular shape.
